(19) United States
(12) Patent Application Publication
(10) Pub. No.: US 2009/0293005 A1
(43) Pub. Date: Nov. 26, 2009

(54) System and method for user interface design generator for data management applications

(75) Inventor: Albertus Martinus Hooyman, Utrecht (NL)

Correspondence Address: HEWLETT-PACKARD COMPANY;Intellectual Property Administration, P.O. Box 272400, Fort Collins, CO, 80527-2400, US

(73) Assignee: Electronic Data Systems Corporation, Plano, TX (US)

(21) Appl. No.: 12/154,293

(22) Filed: May 20, 2008

(51) Int. Cl. G06F 3/048

(52) U.S. Cl. 715/762

(57) ABSTRACT

A system for user interface design, including an application information model stored in a data processing system storage. The system also includes a user interface design generator configured to retrieve the application information model, apply known patterns of requirements and interaction for data management activities, and produce and store a user interface design specification according to the application information model and the known patterns of requirements and interaction for data management activities. Also, there is a method for producing a user interface design specification. The method includes transforming an application information model into a functional requirements specification, combining the functional requirements specification with the application information model to produce a user interface functional specification, deriving an application navigation structure from the user interface functional specification, combining the user interface functional specification and the application navigation structure to produce a user interface design specification and storing the user interface design specification.

### TECHNICAL FIELD

The present disclosure is directed, in general, to design systems and methods.

### BACKGROUND OF THE DISCLOSURE

Time spent dedicated to user-interface code development and specification is time that could be better spent on substantive software development.

### SUMMARY OF THE DISCLOSURE

According to one disclosed embodiment, there is provided a system for user interface design, including an application information model stored in a data processing system storage. The system also includes a user interface design generator configured to retrieve the application information model, apply known patterns of requirements and interaction for data management activities, and produce and store a user interface design specification according to the application information model and the known patterns of requirements and interaction for data management activities.

According to another disclosed embodiment, there is provided a method and a data processing system configured to perform a similar method. The method includes transforming an application information model into a functional requirements specification, combining the functional requirements specification with the application information model to produce a user interface functional specification, deriving an application navigation structure from the user interface functional specification, combining the user interface functional specification and the application navigation structure to produce a user interface design specification and storing the user interface design specification.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of a GUI design generator in accordance with a disclosed embodiment; and

FIG. 3 depicts a process flow in accordance with a disclosed embodiment.

### DETAILED DESCRIPTION

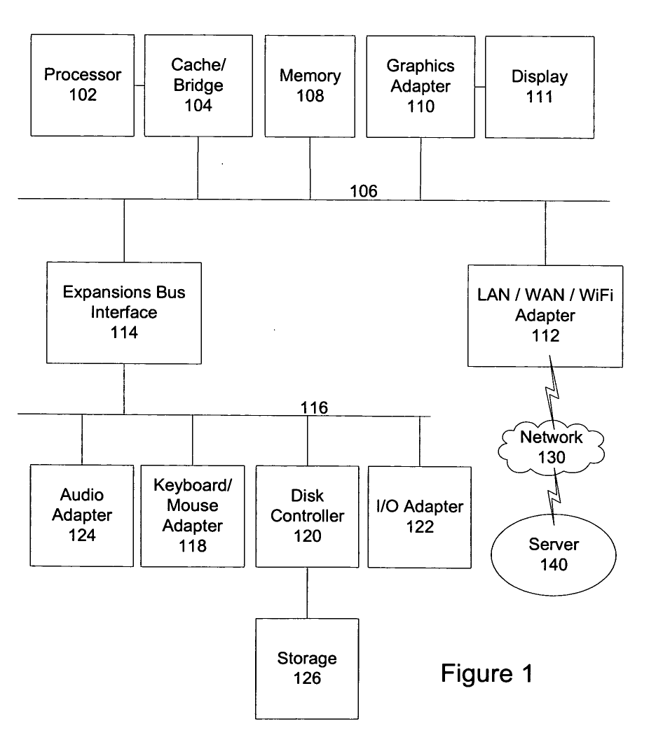

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In software development, a large fraction of the actual code to be designed is involved with the manipulation of supporting information, required to maintain the core business function. Examples of this type of information are: lists of countries, lists of legal entity types, lists of client corporation structures etc. For all of these, data maintenance functions and screens such as search, list, print, and edit are required. The effort to create such capabilities commonly represents in excess of 70% of the total development effort. This effort is not spent on solving a real business problem and as such is often considered wasteful. The code required for performing these very basic functions, necessary to virtually any application, is commonly referred to as “CRUD” code. “Crud” comes from an acronym for functions such as Create, Read, Update and Delete, four basic functions of persistent storage and user interfaces. The systems and methods disclosed herein help reduce the effort for this particular type of code to a minimum.

Various embodiments include systems and methods for generating detailed user interface specifications from a formal description of functional requirements. The formal description language captures all required elements of information modeling and functional specification. The resulting design specification is the input for further runtime generation of user interface logic which is a commonly known technique. The same output can also be used for the generation of user documentation, software test scripts and visual prototypes.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Many general code-generation techniques take a detailed specification and translate that into executable logic. These code generators require a detailed input specification and only address the final step of transforming such a specification into executable code. For user interfaces, these generators typically produce a technology-specific implementation.

For example, one other solution that addresses the automated generation of CRUD user interfaces in a limited way is the Ruby on Rails™ open-source web development framework. This framework does provide some level of automation but aims at very simple information models (active records) without taking into account the complex hierarchical relationships. Also, this framework does not provide any elaborate navigation within a (web) application.

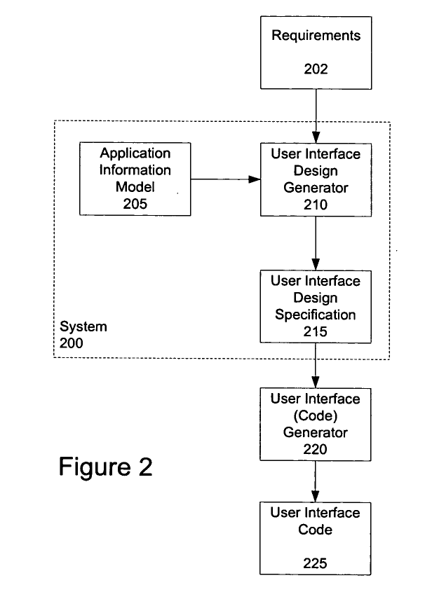

FIG. 2 depicts a block diagram of a GUI design generator in accordance with a disclosed embodiment, as may be implemented on data processing system 100. Data processing system 100 can be configured to perform processes as described herein; and various elements below can be implemented as special-purpose hardware or software modules, or combinations of hardware and software.

As illustrated here, in System 200, User Interface Design Generator 210 produces a detailed User Interface Design Specification 215 from a concise Application Information Model 205 stored in a data processing system storage and known patterns of requirements and interaction for data management activities (CRUD functions), shown as Requirements 202. The output of system 215, the User Interface Design Specification 215, is processed by a user interface code generator 220 to produce User Interface Code 225.

As recognized by those of skill in the art, the functional specification of CRUD-style application logic can be captured using a known set of use cases. The various embodiments disclosed herein capture those use cases in a concise formal language that uses only a few words to describe the desired features.

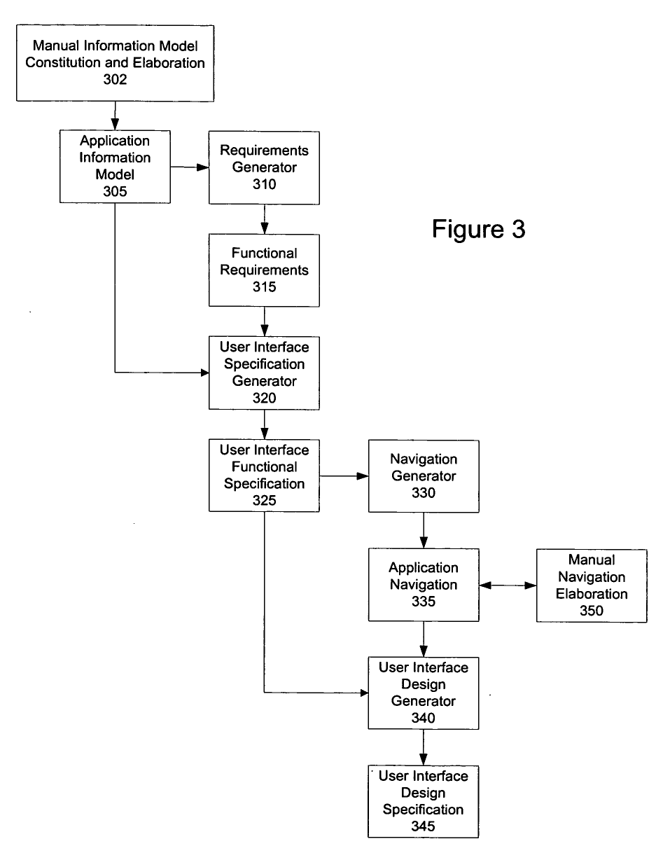

FIG. 3 depicts a process flow in accordance with a disclosed embodiment, as may be implemented on data processing system 100. Here, the Application Information Model 305 represents the functional specification in this formal language, and can be the result of a manual information model constitution and elaboration process 302.

The Requirements Generator 310 transforms the Application Information Model 305 into a Functional Requirements Specification 315, again in a formal language. Functional Requirements Specification 315 is more detailed in its description of the functions and features but ignores any attribute-level details.

User Interface Specification Generator 320 combines the Application Information Model 305 with the Functional Requirements Specification 315 to produce a detailed User Interface Functional Specification 325. In this specification, the exact content of every data entry form, every display page and every summary table view is captured.

Navigation Generator 330 derives an Application Navigation structure 335 from the User Interface Functional Specification 325.

User Interface Design Generator 340 combines the functional specification 325 and the Application Navigation structure 335 into a User Interface Design Specification 345.

The intermediate results allow code designers to inspect the generation process and edit the intermediate results where required (shown as Manual Navigation Elaboration 350 and Manual Information Model Constitution and Elaboration 302). Also, because only the final User Interface Design Generator 340 requires complete and consistent input, an iterative approach is possible whereby a partially complete functional specification can be created based on incomplete input.

The resulting User Interface Design Specification 345 includes references to a set of commands that represent application logic that must be executed where appropriate, for example the ‘save’ command implies that the data entered in a form must be stored by the application. The User Interface Design Specification 345 further describes what the desired output is that should be displayed following the completion of any such command. For the example given, after a save command, the desired subsequent output could be a display of the saved information.

The generated User Interface Design Specification 345 is not specific to an implementation technology. Instead, it captures the intent of the user interface design in a neutral formal language. This allows the output to be used for generation of application code in any technology of choice, including Java, Ruby, .Net, Perl, Python, PHP.

The key difference between the proposed solution and most earlier solutions is that the proposed solution starts from an information model with concise functional requirements, producing a user interface design as output. Most earlier solutions start with a user interface design and generate executable code from that design.

A difference between this solution and prior solutions is that the information model allows for the specification of associations which model entity relationships. There is no limit to how complex such associations may be.

A second difference is in how actual data sets are typified. The solution makes a distinction between the management of entities of which there are only a handful versus entities of which there can be numerous or even unlimited numbers. Different user interfaces are needed based on this distinction. For entity associations, the solution does not follow the classic ‘relational’ modeling but instead uses a more intuitive description to characterize the nature of such relationships. Associations can be of type passive, membership or dependent which specifies the intended interaction with these associations, not their technical implementation.

A third difference is that this solution generates design specifications for chunks of output known as panes. These panes are logically coherent groups of information that always go together. An example is a list pane which is a combination of a tabular display of summary information, combined with interaction elements for navigating through pages of summary data and interaction elements that represent commands that can be applied to the entity instances begin displayed. How such a list pane is combined with other panes to form a screen design is left out of the design to ensure full freedom to user interface designers. The assembly of panes into actual application screens is naturally automated using further formal transformation steps, not part of this invention.

The disclosed embodiments accept a much more condensed input which represents the functional requirements, exclusively, as compared to other solutions. Known use case patterns, page flow patterns and command patterns are used to transform such a condensed specification into a detailed user interface design specification. The benefit is the reduced time and effort needed to prepare the input.

The disclosed embodiments can be applied without constraints in any target technology environment. This is in contrast with frameworks such as the Ruby on Rails™ framework that produces Ruby code, exclusively. The benefit is that the disclosed embodiments can be applied not only across industries and business domains but also across various technology stacks.

The disclosed embodiments leave page composition and page component design to subsequent stages, to ensure the transformation technique does not force the use of specific screen layouts or screen component usage. As an example, the design specification for a data entry form that includes a date field does not enforce the use of a specific calendar widget or date picker. The benefit is that the disclosed embodiments can be made to work within the constraints of any given “style guide” or “site design specification” typical of today's web-enabled business applications.

The disclosed embodiments clearly elaborate the required application functions (commands) that are needed to realize the desired functionality. The separation of user interface from command implementation results in application logic that is easier to maintain and extend in the future.

The disclosed embodiments reduce the effort and cost needed to produce the non-critical part of many business applications, allowing the software design team to focus on the truly relevant use cases and design problems. The disclosed embodiments enforce a consistent user interface design style, thus increasing the perceived quality and lowering the learning effort.

The disclosed embodiments can also be used for the purpose of rapid prototyping, delivering high-quality visual prototypes that match a client's design guidelines. Furthermore, the disclosed embodiments can be used to generate application specification documents and functional test scripts.

The disclosed embodiments reduce time and effort needed to specify, design and implement the user interfaces for data management features within bespoke software development projects. The disclosed embodiments enhance the overall perceived quality of such user interfaces in terms of richness of interaction, consistency of style and completeness of function.

Various disclosed embodiments include a highly condensed input format using a formal notation, capable of describing an arbitrarily complex information model with multiple levels of hierarchy.

Various disclosed embodiments include a chain of input transformations, each one adding more and more details to the specification.

Various disclosed embodiments include an iterative approach that focuses on entities first, then on relationships, then on entity attributes and finally on projections which specify subsets of data attributes.

Various disclosed embodiments include the concept of panes which are logically coherent parts of larger (web page) screens as output containers.

Various disclosed embodiments include the identification of the Copy operator in addition to the well known Create, Read, Update and Delete (CRUD) operators,

Various disclosed embodiments include the distinction between ‘handful’ and ‘numerous’ occurrences. The interaction with small sets of entities and/or associations is always different form the interaction with large sets.

Various disclosed embodiments include the description of interaction with entity associations using terminology that is more close to the use of these interactions than their underlying formal relational specification; using terms such as “passive association”, “membership association” and “dependent association”.

Various disclosed embodiments include the concept of projections which are attribute enumerations that specify a particular view on an entity instance. These projections can contain simple entity attribute as well as attributes of associated entities.

Various disclosed embodiments include the concept of a closed set of commands that model (server-side) processing.

Following is exemplary code for a sample application information model in accordance with disclosed embodiments:

Following is exemplary code for a sample user interface design specification in accordance with disclosed embodiments:

A generator as disclosed herein can accept, as input, an information model extended with some minimal functional specifications. The generator applies the use case patterns, page flow patterns and MVC patterns.

The input is organized as a collection of entity definitions. Each entity definition can include the properties of the entity (data attributes), the associations of the entity (relationships with other entities), the dynamics and the services applicable to the entity (data manipulation), and the projections of the entity (property display lists).

The generator output is organized as a collection of pagegroups; each pagegroup defines the user interface for the management of one particular entity type. Note that there need not be a pagegroup for every entity defined in the input, as some entity types may be dependent on others in which case their manipulation is completely embedded within the ‘parent’ pagegroup. Within each pagegroup, there is no notion of pages or screens, instead, the user interface is defined in smaller units called panes. There are currently up to twenty-three distinct pane types defined; each type is specifically meant to represent an atomic chunk of user interface. This can be very simple, for example the dowiththispane which is just a container for one or more command buttons. More complex panes are the editformpane and the memberspane, which are logical representations of complete data entry forms.

This approach has been taken because any data management application, regardless of its styling, inevitably requires the features represented in these panes. The generator output provides enough information for subsequent transformations to turn the logical representation into an actual screen rendering that complies with a local style guide or interface strategy, as per the two-step view pattern. Furthermore, panes can be combined in endless ways. For example, many data management applications make use of the “Two-panel Selector” pattern. In terms of the user interface panes, this is a combination of a list pane with a view pane. Similarly, many user interfaces combine a search form with the search results (as a list). This would be a combination of a findpane and a listpane.

Through the use of logical panes, any combination of panes can be used to create final screens or web pages. To generate a complete user interface, a style-compliant rendering of each one of the twenty three pane types must be provided (as a template) as well. Code generation techniques can be used to transform the pane representations into actual screen layouts.

The generator works with a sequence of transformations. The intermediate results are all XML documents with associated XML schemata. This allows for manual intervention in cases where the default actions of the generator do not generate the desired output.

The first transformation takes the information model and derives the key functional requirements based on some of the entity properties. In particular, the first transformation considers the entity extent, the entity dynamics, its services and its associations.

In a sample input, the extent can be identified as “numerous” which means there will be potentially many instances of the Takeout entity type. The implications are that a list feature, a search feature and a filter feature are required, and the list feature will need pagination. The entity dynamics are specified as “final” which means that new instances can be created but not modified or deleted. So there will be a ‘create’ feature but no ‘update’, ‘copy’ or ‘delete’. For the dynamics attribute, there is a long list of allowed values including full—new, update, delete; withcopy—copy, new, update, delete; final—new; and readonly—none of the manipulation.

Further to these, a large number of combinations of the cyrud acronym letters are valid. Specifically: cyrud, cyru, cyud, cyrd, crud, yrud, cyu, cyr, cru, cud, crd, yru, yud, yu, ru, cu, cr, u and r. Some of these combinations do not have the r letter meaning you wouldn't be able to retrieve such information for viewing. In these cases, the u letter is always present and hence single instances are displayed in edit mode. This is also known as “expert” mode.

A Takeout instance has at most one related copy and at most one related borrower. There are no special features needed for singleton associations but associations with extent “handful” or extent “numerous” would have drilldown features to allow user to navigate to those associated entities. Finally, there is a single service defined with scope “instance”. Services are transformed into features that are accessible as commands from the user interface, typically as buttons. In this case, one would expect a “Print” button whenever the details of a single Takeout are shown.

The requirements are split in collection-specific features and instance-specific features. For entity types with extent “singleton”, there would of course be no collection features. Note how the dynamics “final” are transformed into the acronym “cr” which implies ‘create’ plus ‘retrieve’ Final entities can be created but never changed nor deleted.

The second intermediate stage involves the transformation of requirements into pyramids which are early renditions of the final panes. The pyramid generator identifies the top-level panes, these are the panes that may subsequently be combined into screen or page layouts. Some panes are completely empty, others are populated with command buttons. In this transformation, the known patterns for use cases and page flows are applied, and some of the known MVC command verbs are introduced.

The features pane provides the generally available commands that would normally apply to the Takeout entity irrespective of the screen being displayed. These features form the internal navigation within the Takeout pagegroup. The filter pane, still empty, is a placeholder for potential filter elements. Filters form single-click selectors over the entity domain. The filter pane is included here because the extent of Takeout is “numerous” so we must expect that there is a need for rapid reduction of the domain into a manageable set of instances for further viewing or processing. The list pane, with its landing attribute, defines the summary view of lists of takeouts. Note how this pane is a container for further panes, in this case a table pane and a pagination pane. The view pane is similar, this pane is a container for a details pane, a pagination pane and a dowiththis pane. The pagination pane is intended for stepping through the current list of Takeouts. The dowiththis pane provides the command buttons that apply to the single Takeout being displayed. As Takeouts are final, there is no delete button, no copy button and no update button. In many cases the dowiththis pane would have such buttons. There is one button though; a service button for the print command. Finally the edit pane holds an editform and a dowiththis pane. On the edit page, one would expect a save button and a cancel button. Note that there is no way to edit an existing Takeout instance but an edit form is still needed for the “new” feature.

The third intermediate stage takes the pyramids from the previous stage and extends those with projections. A projection is an enumeration of the data fields that should appear in a pane. For a table pane, that would be table columns; for an editform it would be the form elements, for a filter pane these are the attributes to filter by. Projections are taken from the original information model. Note that requirements and pyramids can be generated without the need for projections, but panes do require these projections to be present. All projections are typed, so the pane generator would know which projection to apply. Valid projection types are: list, view, find, edit, filter and specialization. The information model may hold more than just one projection of the same type in case the type is one of view, find or edit. The pane generator will simply generated multiple panes of the same type, each with a different projection. These panes will all have a name which is the name given to the projection. Why is this useful? Consider a very complex entity, one with hundreds of properties. It wouldn't be very helpful when the data entry form for such an entity would simply dump all properties in one huge form. Instead, content should be grouped and displayed in chunks, perhaps using a card stack or closable panels. Each panel or card requires its own projection. The same goes for view panes. Multiple find panes are helpful if you want to realize both basic search and advanced search—simply define two projections.

A property reference “*” is used to refer to all properties of the Takeout entity. Also, “copy.publication.title” refers to the title property of the associated entity that is connected to Takeout via “copy.publication”. This format uses a dotted sequence of association names to ‘travel’ from one entity type to another. In this case, “copy” associates Takeout with Copy, and “publication” links Copy to Publication (the details of Copy and Publication are part of the same information model file, even though they are not shown here).

Each property in this case specifies both a column header and a field label. The generator knows what it is doing and applies the column header for elements in tables, and the field label otherwise. Also note that the item specifications for an individual projection provide an overriding value for the label as it is to be applied in that projection. A good example where this is useful is where we use the fullname property of the Staff entity; we label this property as “Borrower” because that is the role of the Staff instance here.

The final stage of output generation focuses on extending the logical representation with hyperlinks. These are added to all command buttons but also to all table columns and details screens that contain navigable content. In the table pane, this is used to drill down from a summary view to a details view.

The sitemap generator takes a panes specification and combines it with a site navigation specification to form a site map. The navigation specification is created in a separate transformation and held as another XML document. The reason for this is that the information model makes no assumptions about how data management is organized in menus and sub-menus. The generated navigation specification puts all eligible entity page groups in one choicegroup (the logical representation for either a menu or a tabbed GUI). This specification can be elaborated or modified as desired and merged into the final sitemap afterwards.

In the table pane, the first column holds the (identifying) attribute “id”, and this column has been transformed into a drilldown column: clicking on a Takeout ID should result in the display of the details of that takeout. In the details pane, most elements are not clickable but all associated values (in this case: the borrower and the title) are made clickable. The effect would be that, when a user clicks on the borrower's name, the screen would display all takeouts by that same borrower. The syntax that is used for the link attribute uses a colon-separated from. The final part of the link is the name of the pane that should be displayed, all parts that precede the pane name are pagegroup names. In most cases, there will be exactly one such pagegroup name but in drilldowns there are links that point to other panes in the same drilldown; here the link path has multiple parts.

The example so far has worked with a simple information model with two singleton associations. The more complex user interfaces result from entities with multiple associations that are either handful or numerous. For these, each entity would be associated with a collection of other entities through one association. In the detailed view page, one would expect to be able to see those associated entity instances, and possible navigate to their details. When there is more than just one such association, there will be multiple drilldowns in parallel and the UI must provide a way to show all of them, perhaps in a card stack or using closable panels.

A drilldown can be passive which means that the associated entity type has its own data management GUI and clicking on a drilldown means navigating away from the current context into the associated entity's context. This type of drilldown is often recognized as a “whereused” navigation. It is actively managed at the other end, and only passively displayed at this end. The GUI for a passive association would consist of a list pane, only.

Another kind of association is the “membership” association, which allows for selection of members from a predefined collection. A good example would be adding keywords to a publication. Each publication can have many keywords, but the keywords are known in advance (managed independently). The membership association suggests a user interface that allows adding and removing keywords from a publication without actively managing the keywords themselves. At the database level, this is identical to managing an n:m relationship using an intermediate table. In a membership GUI, one expects two panes: a list pane and a membership editor. The list pane shows the current set of members, the membership editor allows modification of the set of members. It has a save and a cancel button as usual.

The third, and most complex, association kind is the “dependent” association. This refers to associations where the remote entity cannot exist outside of the context of the associating entity. An example would be the association between Publication and Copy. A publication describes a book as it is published, with title, year of publication etc. A copy represents a physical printed book; a library would have more than one copy of the same publication. A copy cannot exist without reference to a publication, so Copy is a dependent entity. For these, the user interface of Publication would have a drilldown to Copies which is a completely self-contained pagegroup within the Publication pagegroup. In the page design, such a drilldown would normally find its place on the Publication details page. In our logical representation, we simply represent the drilldown as a specific pane type.

Both the keywords and the authors associations are of kind “membership”; these are both n:m relationships at the database level. Publisher and category are singleton associations, and copies is of kind dependent and extent “handful”. So within the UI for Publications, we would expect to see an embedded UI to manage copies of each publication. As described above, the details op the copies drilldown (a dependent drilldown) and the keyword drilldown (a membership drilldown). Note how the pagegroup within the copies drilldown represents the full data management sitemap of the Copy entity—there is no other place in the sitemap where this pagegroup will occur. Also note how, within drilldown pagegroups, command links have an extended path notation that refers to a pane within a pagegroup within a pagegroup (within a pagegroup).

A projection for Publication can include properties from either Publication, Copy, Publisher, Category, Author or Keyword (and even more indirectly associated entities). Some of these properties are themselves not singletons, for example each Publication can have more than one keyword. This can still be displayed as part of a regular details pane. The logical representation of this details pane does not specify how the multiple author names should be rendered, but the fact that there can be more than one is clearly stipulated.

Commonly, multiple projections of the same type are included in the information model. This is valid for view panes, edit panes and search panes.

When multiple view panes of are present in the information model, the final output will include a viewgroup pane which is a container for all of those view panes. The decision how to render these various views is left for subsequent processing.

In some cases, the instances of an entity that is defined in the information model are not naturally managed as a unified group. Instead, there is some distinguishing attribute that acts like a filter on the domain, and the data management is applied only after the filtering has taken place. An example could be the language of a publication. Rather than working on the total collection of publications, one would first select the language and subsequently work on all publications in that language. Similarly, each takeout in the library would be in either a “taken out”, “late return” or “returned” state. It would make sense to filter instances of Takeout on this status before managing the instances. This type of upfront filtering is referred to as specialization. The difference with a normal filter is that any search operation would apply to all instances irrespective of an earlier use of a filter, but the specialization would remain in effect until the user explicitly navigated to the specialization page to define a new specialization. Also, the specialization is not optional; it is always in effect.

There can be multiple specialization projections in an information model, and these transform into multiple specialization panes. The way these are handled is different from how multiple view panes or multiple edit panes are treated—they are not put in a group. Instead, they are left as separate panes but they link to each other in the order given in the information model. In this way, a large domain can be cut into small subsets through a sequence of specializations. The final specialization would link to the list pane.

A landing pane identifies one particular pane within a pane group as the preferred initial pane to display, if any. At the topmost level in an independent pagegroup, the list pane is normally the landing pane, except when there is a specialization in effect. In that case, the specialization would be the landing pane (in the multiple-specialization scenario, the first specialization is the landing pane).

In view groups and edit groups, the first view/edit pane present in the information file is tagged as the landing pane.

An information model with associations can quickly lead to very complex user interfaces. Of the three different association kinds, the dependent association in particular is complex as it includes, for the associated entity, its view panes and its drilldown panes. So this leads to a situation where we have a drilldown within a drilldown, and the innermost drilldown could again be to a dependent entity, so there could be even more levels of drilldowns. This is not preferred, and generally only occurs with dependent drilldowns, as for the other two types (passive and membership), there can only ever be a list pane and an edit pane.

For practical reasons, the generator will not allow nested dependent hierarchies, so when a dependent drilldown is defined within another dependent drilldown, the innermost drilldown kind will be transformed to a passive drilldown, forcing the innermost entity to become independent. This is not a limitation in capabilities as it can be shown that it is always possible to construct the actual data relations between the now independent innermost entity and its ‘parent’ through a singleton association from the child end. So instead of creating the child in the context of the parent, the child is created independently and tied to its parent through a singleton association afterwards.

So far we have shown how a final user interface design (a.k.a. a sitemap) is created from an information model through a sequence of transformations.

The information model does not have to be complete or even consistent initially, when the first transformations are applied. It is perfectly acceptable to start with a nearly empty definition of your principal business entities.

An exemplary formal language that can be used in certain implementations described herein is described, e.g., in “Data Management Request Processing—An MVC Pattern Language” (Hooyman, MphasiS White Paper version 1.0, April 2005), available at time of filing at www.mphasis.com/pdfs/Data_Management_Request_Processing.pdf, in “Data Management Requirements—A Use Case Pattern Language” (Hooyman, MphasiS White Paper version 1.1, January 2005), available at time of filing at www.mphasis.com/pdfs/Data_Management_Use_Cases.pdf, and “Data Management Information Architecture—A Page Flow Pattern Language” (Hooyman, MphasiS White Paper version 1.1, January 2005), available at time of filing at www.mphasis.com/pdfs/Data_Management_Page_Flows.pdf, all of which are hereby incorporated by reference.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within or encoded on a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC § 112 unless the exact words “means for” are followed by a participle.

What is claimed is:

1. A system for user interface design, comprising:
an application information model stored in a data processing system storage; and
a user interface design generator configured to
retrieve the application information model;
apply known patterns of requirements and interaction for data management activities; and
produce and store a user interface design specification according to the application information model and the known patterns of requirements and interaction for data management activities.

2. The system of claim 1, further comprising a user interface code generator configured to process the user interface design specification to produce user interface code, and further configured to store the user interface code.

3. A method for producing a user interface design specification, comprising:
transforming an application information model into a functional requirements specification;
combining the functional requirements specification with the application information model to produce a user interface functional specification;
deriving an application navigation structure from the user interface functional specification;
combining the user interface functional specification and the application navigation structure to produce a user interface design specification; and
storing the user interface design specification.

4. The method of claim 3, wherein the application information model represents the functional specification in a formal language.

5. The method of claim 3, wherein the functional requirements specification does not include attribute-level details.

7. The method of claim 3, wherein the functional requirements specification is more detailed than the application information model.

8. The method of claim 3, wherein the user interface functional specification includes the content of every required data entry form, display page, and summary table.

9. The method of claim 3, further comprising receiving manual edits to the application navigation structure.

10. The method of claim 3, wherein the user interface design specification includes references to a set of commands that represent application logic that must be executed.

11. The method of claim 3, wherein the user interface design specification describes what the desired output is that should be displayed following the completion of a command.

12. A data processing system comprising a processor and accessible storage, the data processing system configured to perform the steps of:
transforming an application information model into a functional requirements specification;
combining the functional requirements specification with the application information model to produce a user interface functional specification;
deriving an application navigation structure from the user interface functional specification;
combining the user interface functional specification and the application navigation structure to produce a user interface design specification; and
storing the user interface design specification.

13. The data processing system of claim 12, wherein the application information model represents the functional specification in a formal language.

14. The data processing system of claim 12, wherein the functional requirements specification does not include attribute-level details.

15. The data processing system of claim 12, wherein the functional requirements specification is more detailed than the application information model.

16. The data processing system of claim 12, wherein the user interface functional specification includes the content of every required data entry form, display page, and summary table.

17. The data processing system of claim 12, the data processing system further configured to receive manual edits to the application navigation structure.

18. The data processing system of claim 12, wherein the user interface design specification includes references to a set of commands that represent application logic that must be executed.

19. The data processing system of claim 12, wherein the user interface design specification describes what the desired output is that should be displayed following the completion of a command.
